(19) United States
(12) Patent Application Publication
(10) Pub. No.: US 2011/0297465 A1
(43) Pub. Date: Dec. 8, 2011

(54) Retrofit Assembly for Self-Mobilization of a Transport Unit

(76) Inventors: Paul N. Huntley, Cheshire, CT (US); John Raudat, Kalispell, MT (US)

(21) Appl. No.: 13/082,693

(22) Filed: Apr. 8, 2011

Related U.S. Application Data
(60) Provisional application No. 61/342,027, filed on Apr. 8, 2010.

(51) Int. Cl. E04G 5/00; E04G 3/28; B60K 1/00

(52) U.S. Cl. 180/65.1

(57) ABSTRACT

A motorized, two-wheeled retrofit assembly converts a portable, four-wheeled transport unit, such as a scaffold, to a self-propelled, power driven unit for directional movement from one location to another. The retrofit assembly is attached to the transport unit in a manner that immobilizes or replaces the front wheels of the transport unit. The retrofit assembly comprises a drive assembly and a steering assembly. The drive assembly includes a pair of freely rotating wheels that are spaced apart from each other and share a common axle. Each freely rotating wheel is disposed adjacent to and detachably engaged with a corresponding slip drive wheel that is fixed to the axle for driving the freely rotating wheels. The drive assembly further comprises a motor; a drive mechanism that operatively interconnects the motor with one of the slip drive wheels for turning the retrofit assembly axle; a power source for the motor; and a base communicating with the axle for carrying the assembly motor and power source. The steering assembly comprises a vertically adjustable steering column.

### CROSS-REFERENCE TO RELATED APPLICATION

This application claims the priority of U.S. Provisional Patent Application No. 61/342,027 filed on Apr. 8, 2010, the entirety of which is incorporated herein by reference.

### BACKGROUND

1. Field of the Subject Matter

The subject matter herein relates to movable transport units used in the construction industry. More specifically, a retrofit assembly is disclosed for converting a manually movable transport unit, such as a scaffold, to a power driven unit for its movement in selective directions from a remote driving and steering location on the scaffold. The retrofit assembly, when attached to the transport unit, can be operated from a platform on the unit that is elevated above the ground regardless of the height of the platform.

2. Related Art

Various devices and apparatus have been disclosed in the prior art for powering and steering scaffolds. U.S. Pat. No. 3,232,375 to Warthen discloses a scaffold containing a powering device having two centrally positioned wheels between the caster wheels at the back of the scaffold, and a steering mechanism using one wheel for steering the scaffold at the front of the scaffold. The steering and powering functions utilize two different mechanisms that are separated from each other by being located at opposite ends of the scaffold.

U.S. Pat. No. 3,930,548 issued to Wallraff discloses a motorized attachment for a scaffold in which each of the two front caster wheels of his scaffold are replaced with a motorized wheeled propulsion unit. Two of the wheeled-propulsion units are therefore required for guiding the scaffold in the forward or backward direction with no lateral direction provided since the wheels of the wheeled propulsion unit are locked in place. As a result, the scaffolding can only be turned in a direction other than forward or backward by powering only one of the propulsion units while the other propulsion unit is non-powered or reverse-powered, thereby complicating the operation of the propulsion unit.

U.S. Pat. No. 4,088,202 issued to Costello mobilizes a scaffolding cart by retrofitting a motor to one of the scaffold's front caster wheels, the direction and forward movement of the wheel being obtained by a steering rod that extends to the top of the scaffold. However, only one wheel is involved for the powering and directional movement of the scaffolding cart thereby making it difficult to transport the scaffold's operator as well as heavy materials that the cart may be carrying.

Other devices disclosed in the prior art, e.g., in U.S. Pat. No. 7,004,284, U.S. Pat. No. 6,533,067 B2, U.S. Pat. No. 5,722,506, U.S. Pat. No. 4,662,476 and in U.S. Pat. No. 4,053,025, utilize the addition of single-wheeled/steering mechanism/power source assemblies to a functionally existing, 4-wheeled scaffold for powering and transporting the same on five wheels. Automotive mobility is therefore achieved by the use of five wheels instead of four.

### SUMMARY

A motorized, two-wheeled retrofit assembly for incorporation with a portable, four-wheeled transport unit having a relatively open framework is provided for directionally moving the unit from one location to another. While other forms of a transport unit are contemplated, the retrofit assembly is particularly adaptable to a movable scaffold that is generally used in the construction industry, more specifically to what is commonly referred to as a “Baker” type scaffold.

The transport unit includes a front and rear framework, each framework comprising a plurality of cross members communicating with upright corner members. Each corner member comprises a support wheel about the base of the corner member. The front and rear frameworks are connected by transverse members for supporting a platform between the front and rear frameworks.

The retrofit assembly comprises a drive assembly and a steering assembly. The drive assembly includes a pair of freely rotating wheels that are spaced apart from each other and which share a common axle. The spacing of the wheels on the axle generally approximate a distance slightly less than the spacing between the transport unit's front caster wheels. It will be understood that the spacing between the wheels on the retrofit assembly can also be equal to or greater than the caster wheel spacing. If it is desired to have the wheel spacing equal to or greater than the spacing of the transport unit's front caster wheels, the front caster wheels of the scaffold can be removed in favor of using the wheels of the drive assembly. In addition, the rear caster wheels of the transport unit can be set to a locked position (as opposed to being freely rotating) to prevent a drifting or “fish-tailing” of the rear portion of the unit when it is actively mobilized by the retrofit assembly.

Each freely rotating wheel of the drive assembly is disposed adjacent to and detachably engaged with a corresponding slip drive wheel that is fixed to the axle interiorly of the freely rotating wheel. The engagement of the freely rotating wheel with its corresponding slip drive wheel is created by a bias means exerted on the wheels against the slip drive wheel, preferably by the use of a spring mechanism mounted about the longitudinal axis of the axle, typically about each end of the axle. The spring mechanism is held in place on the axle by a locking mechanism that is detachably mounted to the axle exteriorly of the spring mechanism. Furthermore, the bias exerted on the wheel by the spring mechanism for causing it to come into contact with its slip drive wheel, is adjustable for allowing the disengagement of the wheel and slip drive wheel from each other when the necessary torque for turning the drive assembly is exceeded. The adjustability is provided by moving the locking mechanism along the axle towards or away from the spring mechanism for increasing or decreasing the amount of torque required to free the wheel from its respective slip drive wheel.

The interfacing of the drive assembly's wheel with its corresponding slip drive wheel is provided by interfacing surfaces on each of the wheels and respective slip drive wheels. These interfacing surfaces are generally at an angle of from 0 to 90 degrees relative to the horizontal axis of the axle, preferably from at 45 degrees, which allows the slip drive wheel to act in the manner of an automotive clutch.

The drive assembly further comprises a motor; a drive mechanism that operatively interconnects the motor with one of the slip drive wheels for turning the axle; a power source for powering the motor; and a base that communicates with the axle for carrying the assembly's motor and power source. The drive mechanism of the retrofit assembly comprises a pulley secured to a drive shaft that extends from the motor, and at least one drive belt that interconnects the pulley with the slip drive wheel of the drive assembly. The motor is preferably a reversible, variable speed motor with sufficient capacity to drive the slip drive wheel in a forward or reverse direction. The power source is generally a battery, preferably one that is re-chargeable, with sufficient capacity to power the retrofit assembly's motor.

The base that communicates with the axle for carrying the assembly's motor and power source preferably rests upon the axle and is secured thereto by means of at least two bearing assemblies, each of which comprises a block member that includes an opening for receiving a bearing means about the circumference of the opening for receiving the axle of the drive assembly therethrough. The fixation of the bearing means within each opening allows the axle to freely rotate in the bearing assembly.

The steering assembly comprises a vertically adjustable steering column that communicates with and rests on the base of the retrofit assembly for turning the drive assembly to a desired position for the directional movement of the wheels. The steering column comprises at least two concentric and mateable tubes for varying the height of the steering column so that the drive assembly can be operated from a position remote therefrom. In order to adjust the height of the steering column, each tube includes one or more pairs of openings located opposite to each other, for receiving therethrough a cross member for maintaining the height of the steering column. In addition to having a circular cross section, the concentric tubes can have a square, rectangular, elliptical or other irregular cross section which alleviates the torsional stress that might otherwise be exerted on the cross member when the steering column is turned.

Further comprising the steering assembly, and disposed about the top portion of the steering column for turning the drive assembly, is a steering mechanism that comprises at least one handle bar, preferably two, one on either side of the steering column. In addition, a control apparatus is disposed about the steering mechanism that is operatively communicative with the motor for electronically controlling the rotational movement of the wheels of the drive assembly. The control apparatus includes a speed control unit for varying the speed of the motor. The control apparatus also includes an electrical switch unit for controlling the forward or reverse directional movement of the motor, which in turn controls the reverse or forward rotational movement of the slip drive wheel of the drive assembly.

For securement of the retrofit assembly to the transport unit, the retrofit assembly additionally comprises an attachment device for detachably securing the retrofit assembly to one end of the transport unit. The attachment device comprises (i) at least one plate member that includes a plurality of openings for receiving the ends of at least one C-bolt therethrough; and (ii) fastening means for detachably engaging the ends of the C-clamp. The openings, C-bolt and fastening means cooperate to engage the plate member with the transport unit for securing the retrofit assembly to the transport unit.

Alternatively, the attachment device may embody (i) a first and second member, each comprising a plurality of openings for receiving the ends of at least one C-bolt therethrough; and (ii) a fastening means for detachably engaging the ends of the C-bolt(s) which can be in the form of threaded nuts or a handle clamp that engages and locks onto each of the ends of the C-bolt. Additionally, each of the first and second members comprises a vertically disposed recess that efface each other for engaging the steering column of the retrofit assembly between the first and second plate members. The second member further comprises a horizontally disposed recess for engaging a cross member of the transport unit. The openings, C-bolt and fastening means are cooperatively configured to contain and secure the steering column within the vertical recesses of the first and second members, and the cross member within the horizontal recess of the second member by means of one or more C-bolts, preferably by the use of at least one pair of C-bolts.

When the retrofit assembly is secured to the scaffold by the attachment device to form a self-propelling transport unit, it is preferably undertaken in a manner that immobilizes the support wheels of the front framework of the scaffold. This is accomplished by first raising the front end of the scaffold a slight distance from the floor, typically by a distance of ¼ inch or greater, and then securing the retrofit assembly to the cross members of the front end of the scaffold while the front end of the scaffold is in the raised position. This in effect immobilizes the front caster wheels of the scaffold in favor of the wheels of the retrofit assembly.

### BRIEF DESCRIPTION OF THE DRAWINGS

A complete understanding of the subject matter may be obtained by reference to the following specification when taken in conjunction with the accompanying drawings wherein certain preferred embodiments are illustrated, wherein like numerals refer to like parts throughout, and wherein the disclosed embodiments are exemplary of the subject matter described herein. It will also be understood that the subject matter disclosed herein may be embodied in various forms, that the illustrated drawings are not necessarily to scale, and that some features of the illustrated drawings may be exaggerated to show details of particular components.

FIG. 1 illustrates a perspective view of a scaffold integrated with a motorized retrofit assembly;

FIG. 1A is an exploded perspective view showing a detail of the manner of connection of a support member to the framework of the scaffold illustrated in FIG. 1;

FIG. 1B is a perspective view of the connection of the support member to the framework of the scaffold illustrated in FIG. 1A by a locking mechanism;

FIG. 1C is a detailed perspective view of the locking mechanism illustrated in FIG. 1 B;

FIG. 2 is an elevated front plan view of the motorized retrofit assembly illustrated in FIG. 1;

FIG. 3 is an elevated side plan view of the motorized retrofit assembly illustrated in FIG. 1;

FIG. 4 is an elevated detailed plan view of a portion of the drive assembly illustrated in FIGS. 2 and 3;

FIG. 5 is a detailed perspective view of the manner of attachment of the steering column to the base of the motorized retrofit assembly illustrated in FIGS. 2 and 3 and the manner of attachment for the axle to the base;

FIGS. 6 is an elevated side plan view of the motorized retrofit assembly illustrated in FIG. 3 showing an alternative embodiment for the attachment of the motorized retrofit assembly to the scaffold wherein the motor controller is now located on the base of the retrofit assembly;

FIG. 7 is a partially exploded perspective view of a portion of the retrofit assembly illustrated in FIG. 6;

FIG. 8 is a top plan view for the retrofit assembly base with the cover removed, portions being shown in phantom, portions removed and portions in schematic;

FIG. 9 is an exploded perspective view of an alternative embodiment of a tiller and telescopic steering column for the retrofit assembly, portions being shown in phantom.

### DETAILED DESCRIPTION OF THE PREFERRED EMBODIMENTS

Throughout the following description, the preferred embodiments and examples are intended as exemplars rather than limitations on the apparatus of the present disclosure.

A motorized, two-wheeled retrofit assembly is disclosed for integration with a movable transport unit in order to propel and control the movement of the unit from one location to another.

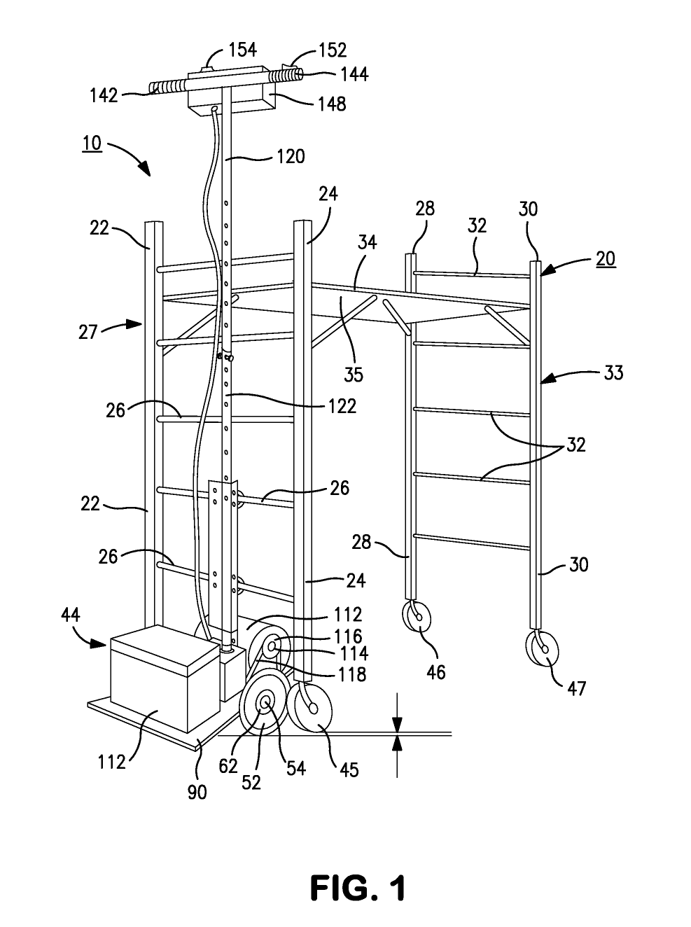

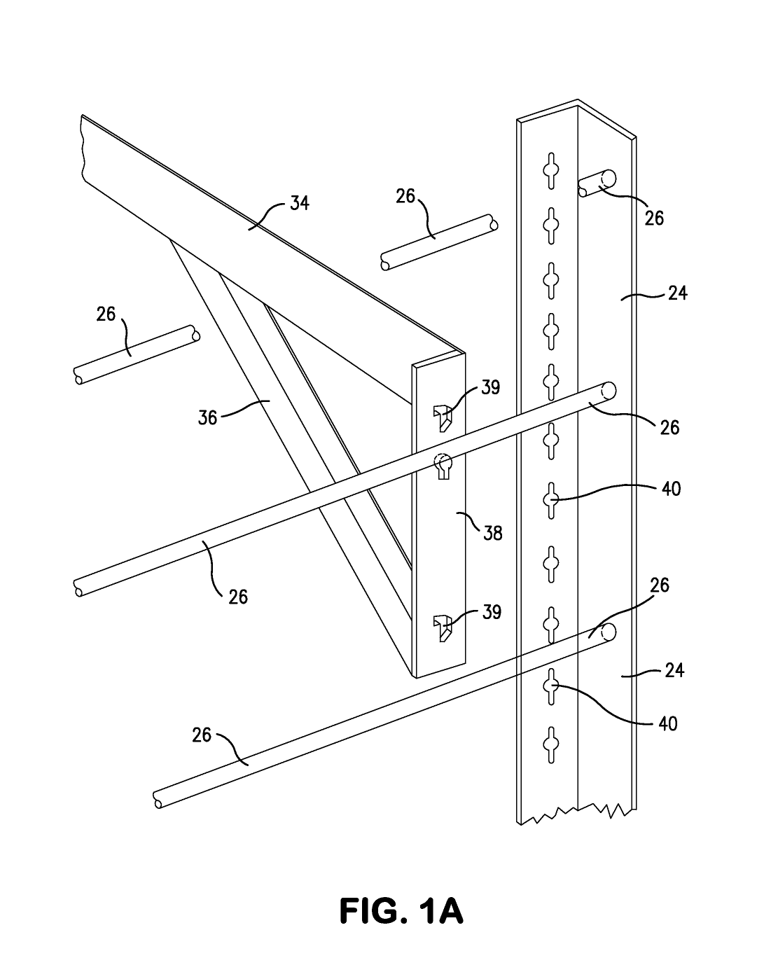

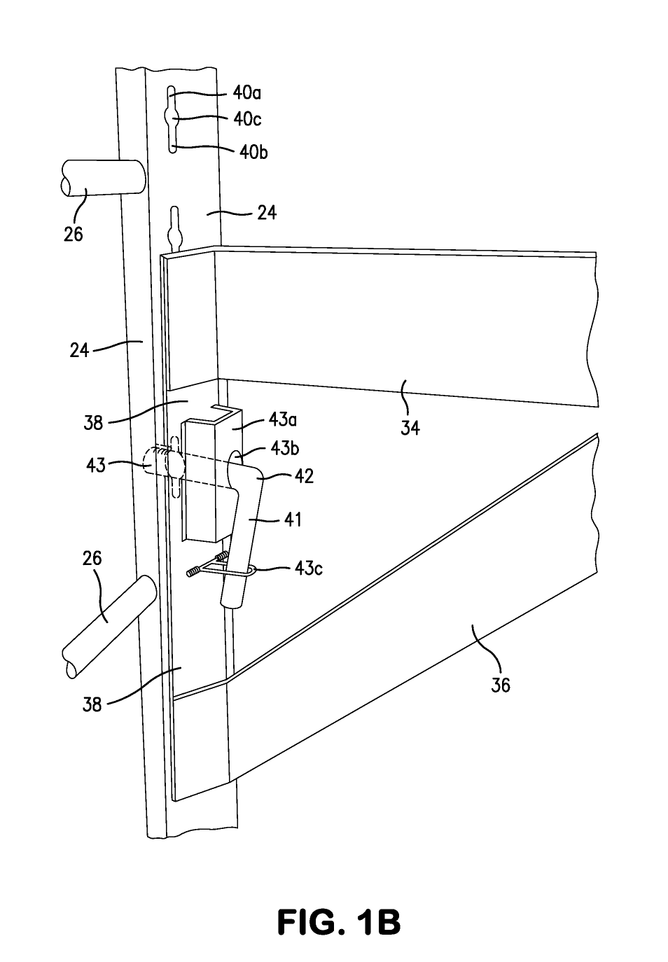

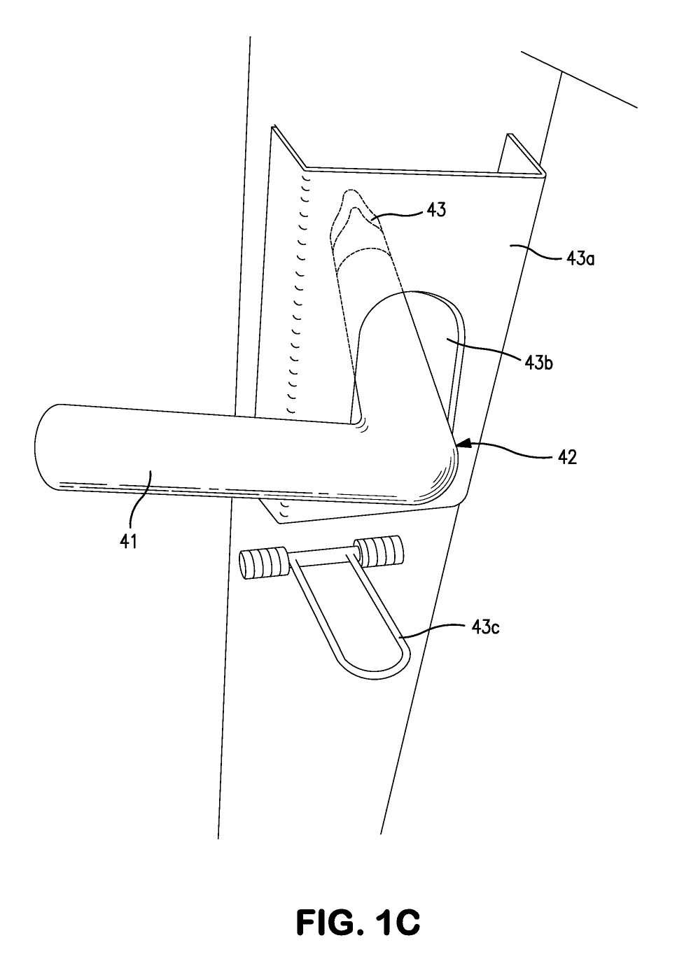

Referring to the drawings, in particular FIG. 1, there is shown for illustrative purposes only, a motorized retrofit assembly 10 incorporated with a transport unit 20 in the form of a 4-wheeled movable scaffold. In the illustration shown, the scaffold has, what is referred to in the construction industry, a “Baker” type construction wherein two vertical posts 22 and 24 are rigidly connected by laterally disposed cross members 26 to define a front framework 27. In similar fashion, vertical posts 28 and 30 are connected by laterally disposed cross members 32 defining a rear framework 33. Vertical posts 22, 24, 28, 30 can have a hollow, circular, rectangular or square cross-section, or as shown in FIG. 1A, can have an L-shaped cross-section. Frameworks 27 and 33 are connected to each other by a pair of horizontally disposed platform members 34, each being supported by a pair of diagonal support members 36 connected to vertical support members 38 at either end of the respective support member 34. Vertical support members 38 and diagonal support members 36, which are generally of a one-piece construction or welded together with the end portions of platform members 34, define a structural configuration for offering a rigid framework for the scaffold.

In order to provide height adjustability for platform members 34 between front framework 27 and rear framework 33, and as shown in greater detail in FIG. 1A, vertical members 38 are provided with one or more hooked extensions 39 that are configured in size and length for insertion into openings 40 which are disposed along the height of posts 22, 24, 28, 30. Openings 40 are spaced apart from each other in approximate equal increments to accommodate receipt of hooked extensions 39 anywhere along the length of posts 22, 24, and for providing height adjustability for platform members 34. As shown more clearly in FIG. 1B, openings 40 are designed with a narrow upper opening 40a and narrow lower opening 40b on the top and bottom of wider opening 40c for receiving and holding the hooked extensions in place.

In addition, and in order to detachably secure the platform members to vertical posts 22, 24, a key bolt member 42 is used for locking the vertical support member 38 with post 24. Referring to FIGS. 1B and 1C, key bolt member 42 comprises an end portion 43 that has a cross-section which conforms to the wider opening 40c and lower narrower opening 40b, and a handle 41 at its opposite end to assist in the turning of the key bolt member. As shown, this is accomplished by turning the key bolt a quarter turn, i.e., 90o counterclockwise after its insertion into opening 40. Key bolt member 42 is prevented from being dislodged from post 24 by means of a retaining box 43a fixed to the side of the post and having an opening 43b through which end portion 43 is inserted. When in the locked position, handle 41 is retained in place by an upwardly biased retaining spring 43c as illustrated in FIG. 1B. To free handle 41, retaining spring 43c is pushed in a downward direction to allow handle 41 to be turned for unlocking the end portion 43 from openings 40b and 40c, thereby freeing support members 38 from vertical posts 22, 24. Once freed, key bolt member 42 can be returned to its secure position within retaining spring 43c by depressing the spring and turning handle 41 to a vertically aligned position for allowing the spring to capture handle 41 (see FIG. 1B).

After support members 34 are secured in place to respective posts 22, 24 and 28, 30 in a similar manner, a platform 35, constructed, for example, of wood or metal, can be placed on top of platform members 34 to provide a surface for standing on transport unit 20 and/or for the placement of construction materials thereon. Platform 35 can also be permanently or detachably secured to platform members 34 by any conventional means.

As illustrated in FIG. 1, freely-rotating caster wheels 44, 45 and 46, 47 are mounted to the bottom of posts 22, 24 and 28, 30, respectively, to aid in the movement of the transport unit in any lateral direction. It will be appreciated that transport unit 20 can have any number of varying framework structure configurations so long as it is possible to attach retrofit assembly 10 to the transport unit. In another embodiment, the rear caster wheels of the transport unit can be set to a locked position (as opposed to being freely rotating) to prevent a drifting or “fish-tailing” of the rear portion of the unit when it is actively mobilized with the attachment of the retrofit assembly, described herein, to the front framework of the transport unit.

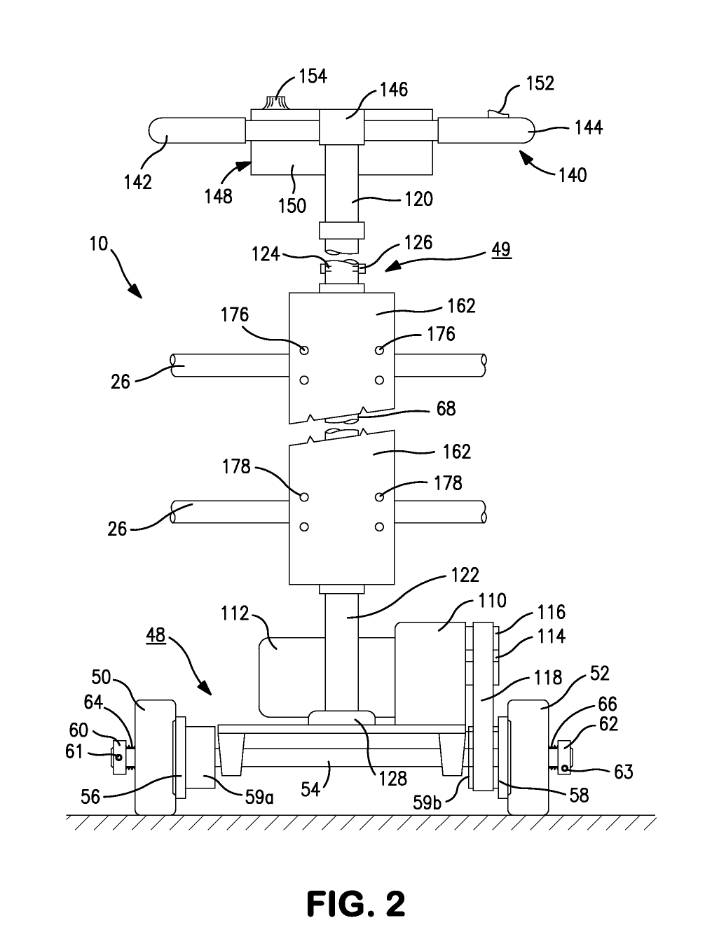

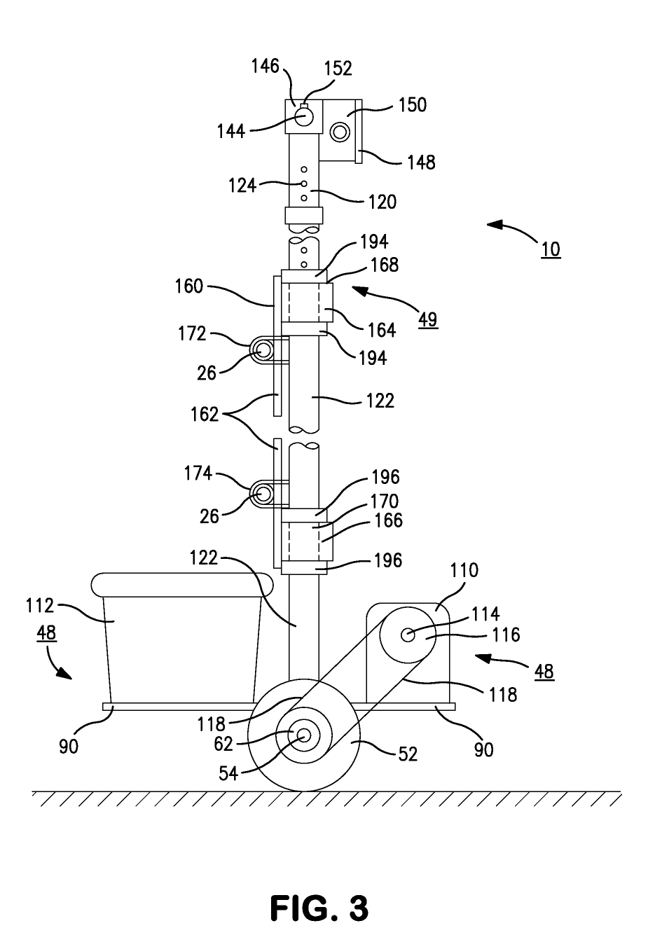

Referring now to FIGS. 2-3, motorized retrofit assembly 10 generally comprises a drive assembly 48 and a steering assembly 49. Drive assembly 48 comprises a pair of freely rotating wheels 50 and 52 disposed about opposite ends of a common axle 54. Wheels 50, 52 are spaced apart by a distance slightly less than the distance between caster wheels 44, 45 of transport unit 20 to allow turning of drive assembly 48 by the steering assembly 49 without interference from caster wheels 44, 45. In this setting, it will be understood that the spacing should not be so minimal as to cause an imbalance on the transport unit to which the retrofit assembly is attached to, e.g., to cause a tipping of the transport unit when making sharp turns. Therefore, in this circumstance where the caster wheels of the scaffold are immobilized by, for example, the raising of the front end of the scaffold, the spacing should be slightly less than the spacing between the support wheels upon which the front of the transport unit rests. For the purposes of the disclosure herein, the phrase “slightly less” is meant to mean a clearance distance in which the wheels of the retrofit assembly will not be obstructed by the front caster wheels of the transport unit when the wheels of the drive assembly are turned in either a left or right direction. The clearance distance is generally from 1 to 2 inches.

It will be understood that the spacing between the wheels on the retrofit assembly can be equal to or greater than the caster wheel spacing. However, if it is desired to have this configuration of wheel spacing, the front caster wheels of the scaffold can be removed in favor of using the wheels of the drive assembly.

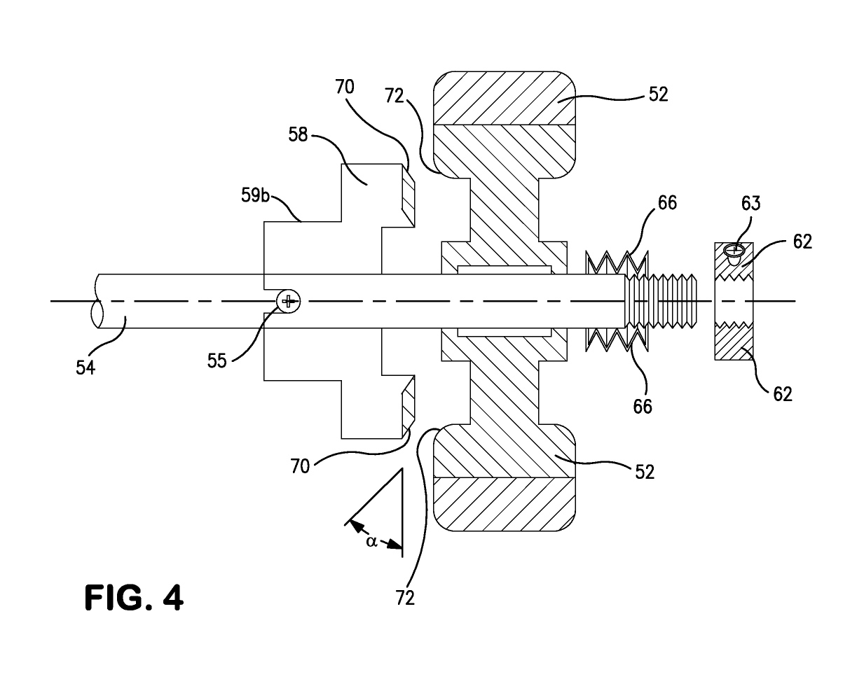

Adjacent to the interior side of wheels 50 and 52 are respective slip drive wheels 56 and 58 whose hubs 59a and 59b are mounted and fixed to axle 54 with a drive pin 55 inserted into the axle (see FIG. 4). The attachment of hub 59b to axle 54 with drive pin 55 governs the rotation of axle 54.

Disposed and fixed about each end of axle 54 are a pair of split collars 60 and 62 that respectively retain springs 64 and 66 about axle 54. Springs 64, 66 also interface with respective wheels 50, 52 and split collars 60, 62 for respectively maintaining a bias of wheels 50, 52 against slip drive wheels 56, 58. The engagement of the freely rotating wheels with their respective slip drive wheels enables wheels 50, 52 to be turned for executing the motorization of the drive assembly.

More specifically, and as shown in greater detail in FIG. 4, the interface of slip drive wheel 58 with wheel 52 is accomplished by providing a clutch interface 70, circumferentially located on the exterior side of slip drive wheel 58, that is configured to interface with a wheel interface 72 located interiorly of wheel 52. Both clutch interface 70 and wheel interface 72 are optimally beveled at approximately 45° (represented by the bevel angle in FIG. 4), although a complementary bevel angle can be used in the range of from 0° to 90°, for effecting engagement of slip drive wheel 58 with wheel 52. For example, if the bevel angle for slip drive interface 70 is 50°, then the bevel angle for wheel interface 72 will be 50°. The force bias of spring 66 against wheel 52 causes wheel 52 and slip drive wheel 58 to be engaged with each other by contact of wheel interface 72 and slip drive interface 70, thereby allowing wheels 50, 52 to be driven by drive wheel 58. The force bias of springs 64, 66 against respective wheels 50, 52 can be adjusted by moving split ring collars 60, 62 inward or outward along axle 54 to create more or less tension, respectively, on wheels 50, 52. Set screws 61, 63 in respective collars 60, 62 can be used to loosen and tighten the collars to the desired position on axle 54. The engagement of slip drive wheel 58 with wheel 52 and its functioning for steering retrofit assembly 10 is discussed in greater detail hereinafter.

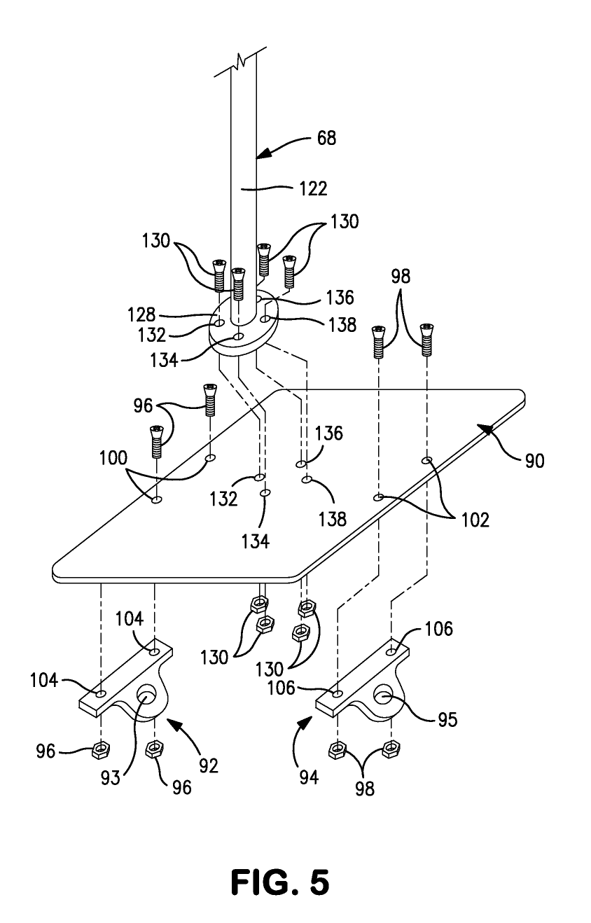

As best illustrated in FIG. 5, motorized retrofit assembly 10 also includes a base plate 90 supported by axle 54 through the use of bearing pillow blocks 92, 94 whose openings 93, 95 retain bearings (not shown) for receiving axle 54 (not shown) to allow for rotation of the axle therein. Pillow blocks 92, 94 in turn are secured to the bottom of base plate 90 using nut and bolt combinations 96, 98 inserted through openings 100, 102 of base plate 90 and openings 104, 106 of pillow blocks 92, 94.

Referring to FIGS. 3-4, interconnecting pulley 116 and the hub 59b of slip drive wheel 58 is a drive belt 118 for the rotational turning of slip drive wheel 58 and axle 54 in a direction that is commensurate with the rotation of drive shaft 114. The hub 59b of slip drive wheel 58 has a smaller diameter than slip drive wheel 58 to maintain the drive belt's alignment with pulley 116. Alternatively, hub 59b of slip drive wheel 58 can be modified with an annular recess for accommodating receipt of drive belt 118 and for maintaining its positioning on hub 59b. In either case, slippage of the drive belt from hub 59b of slip drive wheel 58 is avoided. Alternatively, pulley 116 and the surface of hub 59b can be configured with notched depressions to complement receipt of corresponding notches provided on the interior surface of drive belt 116 (not shown). The configuration of any number of arrangements for interconnecting pulley 116 and hub 59b of slip drive wheel 58 with drive belt 118 are contemplated for the retrofit assembly 10 including a chain and sprocket assembly for driving slip drive wheel 58.

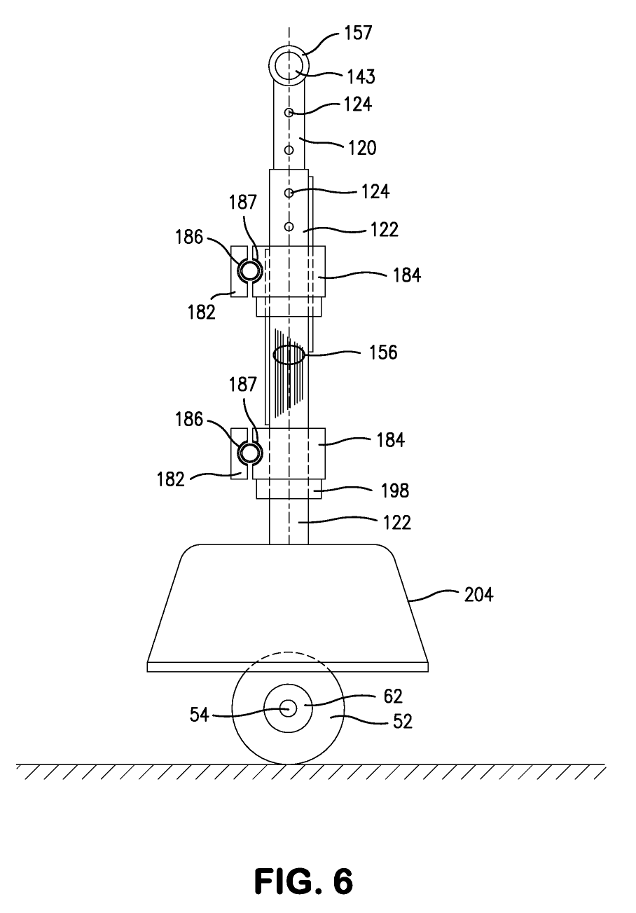

As shown in FIGS. 2-3, base plate 90 also supports a motor 110 and a battery 112 which is used as an independent power source for powering motor 110. Motor 110, which is preferably a reversible, variable speed motor, has a laterally extending drive shaft 114 for fixedly receiving a pulley 116 about the end thereof. Motors of varying capacity and function can be used for powering the drive assembly depending on the weight and size of retrofit assembly 10 and transport unit 20. Battery 112 is provided with sufficient wattage to power motor 110, and is typically a 12 volt battery. Provsion is also made for a battery recharging unit mounted along side the battery on base plate 90. Other sources of power can include an electrical outlet connected to motor 110 for receiving the electrical plug of an extension wire connected to a power source external to the retrofit assembly 10 and/or transport unit 20. As shown in FIG. 6, a protective cover 204 can be placed over the motor and battery to protect against the infiltration of debris or contaminants from the location of where the transport unit is deployed.

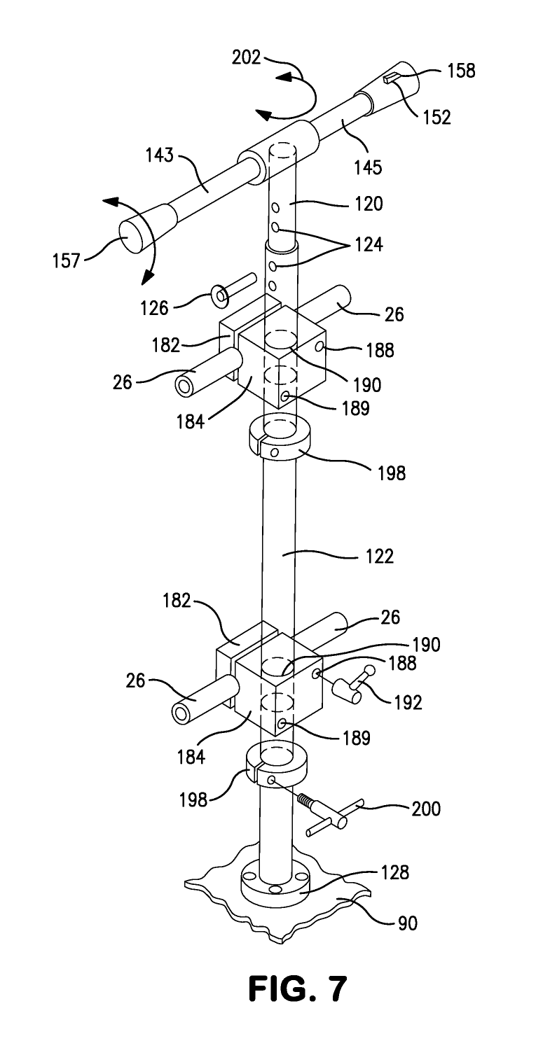

Referring to FIGS. 2 and 5, and as indicated hereinbefore, retrofit assembly 10 further includes a steering assembly 49 that is supported by and attached to base plate 90 by conventional means. More specifically, steering assembly 49 comprises a steering column 68 which is composed of an upper column 120 and a lower column 122; a tiller 140; and a motor controller 148. The upper and lower columns 120, 122 are each preferably constructed of a metal tubular construction, e.g., stainless steel, iron, aluminum, etc., and capable of being mateably engaged with each other in a male/female relationship. Plastic and PVC tubing is also contemplated as a suitable material to construct the upper and lower columns. In this manner, steering column 68 can be vertically adjusted by the use of substantially identical, vertically stepped openings 124 disposed along the length or the partial length of both upper and lower columns 120, 122. Openings 124 are configured in size to receive one or more bolts 126 through both columns (see FIGS. 2 and 7) in order to adjust and fix the height of steering column 68. In this way, the retrofit assembly 10 can be operated and controlled at any height from transport unit 20.

Lower column 122 of steering column 68 is secured to base plate 90 by a collar device 128 fixed about the end of lower column 122, preferably by welding the collar to the column. Collar device 128 and lower column 122 in turn are fastened to base plate by means of four nut and bolt combinations 130 inserted through openings 132, 134, 136, 138 of base plate 90 and collar device 128. It is to be noted that the placement of steering column 68 onto base plate 90 is at a location that is substantially equidistant between wheels 50 and 52. Centrally locating the steering device between wheels 50 and 52 insures ease of steering retrofit assembly 10 when it is integrated with transport unit 20. The lower column 122 can also be mounted on the base off center in the direction parallel to the wheels.

As best seen in FIGS. 2 and 7, a tiller 140 is mounted about the upper most section of upper column 120. Tiller 140 comprises handle bars 142, 144 extending from mounting tube 146 that is detachably fixed to the top of upper column 120 for rotating steering column 68 to a desired position. Various constructions can be used for rotating steering column 68. For example, instead of tiller 140, a steering wheel, having a desired shape or design, mounted to mounting tube 146, can be utilized. In effect, by the use of steering assembly 49, the direction of retrofit assembly 10 and transport unit 20 can be controlled from a location vertically remote from the drive assembly 48.

In order to actuate and control the reverse or forward movement of drive assembly 48, and also its speed, a motor controller 148 is positioned within proximity to tiller 140, preferably at a location that is adjacent to tiller 140. As a specific embodiment, motor controller 148 is attached to tiller 140 by any conventional means, and as shown connected to the tiller 140 with thru bolts or any other means of conventional fastening. As seen in FIGS. 2 and 7, the tiller 140 can be attached to the upper column 120 in a variety of configurations including a machined union 146 which is fastened to the top of the upper column 120 and allows thru passage of tiller 140. The tiller is secured by a set screw (not shown) which passes thru the machined union 146 making positive contact with the tiller. The machined union 146 can be made from any number of materials including aluminum, steel, PVC, plastic, etc. Aluminum is preferable due to its light weight.

Referring once again to FIG. 2, motor controller 148 comprises electronic circuitry within enclosure 150 that connects a directional switch 152 located on handle bar 144, with motor 110 via wires for controlling the clockwise or counterclockwise rotation of pulley 116. This function controls the reverse or forward movement of wheels 50, 52 via drive wheel 54. The powering and speed of motor 110 can be controlled by rheostat dial 154 which is located on the top of motor controller 148 to allow easy access for the retrofit assembly's operator. Rheostat dial 154 is electronically coupled with electrical wiring 156 disposed internally of upper and lower columns 120, 122 and leading to motor 110 (see FIG. 6) for powering the motor and adjusting the motor's rotational speed.

Alternatively, and as illustrated in FIG. 7, instead of using a operation and control of drive assembly 48 can be undertaken by means of a speed controller 157 located at the end of handle bar 143 for controlling the speed of the drive assembly via wiring 156 (see FIG. 6) which is connected to motor 110. Turning the speed controller in a forward direction relative to the retrofit assembly's operator will cause the speed of motor 110 to increase, while turning the controller in the reverse direction towards the operator will cause the motor's speed to decrease, eventually to a setting where the motor will be shut off. A direction controller 158, located about the end of handle bar 145 and shown in the form of a rocker switch 152, is also provided for controlling the forward or reverse movement of drive shaft 114 of motor 110. With this embodiment, both hands can be utilized for the operational speed of drive assembly 48 while simultaneously performing the function of directing and turning the steering assembly 49 for powering transport unit 20 to a desired location. Other electro-mechanical devices may be used for effecting the direction and speed of motor 110, e.g., by the use of a toggle switch and/or lever means.

For purposes of safety, the speed of the transport unit will generally operate in a range of from about 1 foot/second although higher ranges can be used depending on the size, weight and nature of the transport unit. With the Baker type scaffold illustrated in FIG. 1, motor 110, which as indicated hereinbefore is preferably a reversible, variable speed motor, will generally have a capacity range and rpm operating range with a voltage of approximately 110 volts AC and also 12 volts DC necessary to maintain and allow the unit to advance or retreat at a 1 foot/second speed range.

Integration of retrofit assembly 10 with transport unit 20 can be accomplished in any number of ways. In one embodiment, and as illustrated in FIGS. 2 and 3, an attachment device 160 is provided comprising a metal plate 162 fixed to two pivot bearing blocks 164, 166 that encompass lower column 122. Pivot bearing blocks 164, 166 have a vertically disposed, hollow cylindrical opening 168, 170, respectively, for slidably receiving lower column 122 therethrough. Needle bearings (not shown) are preferably provided on the interior surface of the cylindrical openings 168, 170 for interfacing lower column 122 in order to facilitate the rotation of steering column 68 within the pivot bearing blocks. Metal plate 162 is fixed to pivot bearing blocks 164, 166 by any conventional means, e.g., with threaded machine bolts, a nut and bolt arrangement, etc. Once attachment device 160 is assembled onto lower column 122, it is attached to cross members 26 of front framework 27 by means of a pair of threaded U-bracket/nut combinations 172, 174 placed around cross member 26 and inserted through openings 176, 178 of metal plate 162 after which it is fixed to front framework with appropriately sized nuts. Upper column 122 can then be inserted into lower column 120, and bolt 126 (see FIGS. 2 and 7) inserted through the appropriate openings 124 in the lower and upper columns for obtaining the proper height adjustment of tiller 140.

Another embodiment for detachably securing retrofit assembly 10 to transport unit 20 is illustrated in FIGS. 6 and 7 wherein a pair of attachment devices 180 are used to secure retrofit assembly 10 to transport unit 20 instead of using the single metal plate 162 illustrated in FIGS. 2-3. Each of attachment devices 180 comprises a front and rear pivot block support 182, 184, respectively, a pair of bolts 204, 206 with threaded ends (see FIG. 3) for insertion into corresponding openings 188, 189 provided in the front and rear pivot block supports. The rear pivot block support bolt opening is threaded to allow tightening of bolts 205, 206. The bolts are tightened with a pair bolt wrenches included with the retrofit assembly. Each of block supports 182 and 184 have a semi-circular opening 186, 187 (see FIG. 6) that are configured in size to encase cross member 26 of transport unit 20 when the block supports 182, 184 are secured to each other. Furthermore, each of the rear pivot block supports 184 has a vertically disposed opening 190 that is configured in size to slidably receive pivot block spacer column 203 therethrough. The pivot block spacer column is a truncated column section that slides independently and telescopically over the lower column and functions as a receiver for the pivot blocks. In this manner, retrofit assembly 10 can be secured to front framework 27 of transport unit 20 when the bolts 205, 206 are inserted through openings 188, 189 of the front and rear pivot block supports. The pivot blocks are allowed to slide up and down the pivot block spacer column to provide fine tuning for the vertical spacing of the front framework cross members. A collar stop 198 is positioned directly below the lower pivot block and is used to register the vertical position of the block spacer column. The upper pivot block can slide along the block spacer column until it aligns position with the corresponding scaffolding cross member 26.

Generally, the weight of retrofit assembly 10 will be sufficient to provide wheels 50, 52 with adequate traction to maneuver both the retrofit assembly and transport unit 20 across a floor surface. However, in order to provide maximum traction, and before retrofit assembly 10 is attached to transport unit 20, a spacer member 186, which can be in the form of a metal plate having an approximate thickness of between ¼ to ½ inch, is placed under caster wheels 45, 46 to raise the front framework 27 of transport unit 20 off the floor. Retrofit assembly 10 is then secured to two of the cross members 26 in the manner illustrated in FIG. 2-3 or 6-7. Once this is accomplished and the spacer members 186 removed from underneath the transport unit's caster wheels, the function of caster wheels 45, 46 is rendered inoperable, and their function is replaced by wheels 50, 52 of retrofit assembly 10. In short, the movement of transport unit 20 will be borne by wheels 50, 52 of the retrofit assembly and caster wheels 47, 48 of the transport unit, and the added weight of the front portion of transport unit 20 will contribute to the maximum traction of wheels 50, 52.

It will be understood that the spacing between the wheels on the retrofit assembly can be equal to, greater or narrower than the caster wheel spacing. However, if it is desired to have the wheel spacing equal to than the spacing of the transport unit's front caster wheels, the front caster wheels of the scaffold can be removed in favor of using the wheels of the drive assembly.

With the foregoing arrangement, and in order to maintain attachment device 160 and its associated pivot bearing blocks 164, 166 in place about steering column 68 (see FIG. 3), as well as attachment device 180 and its associated pivot bearing block supports 182, 184 (see FIG. 6, 7), collar stops 194 and 196 are placed around and detachably fixed to lower column 122 on either side of pivot bearing blocks 164, 166. In a similar fashion, and as shown in FIG. 6, 7, collar stop 198 is placed underneath only the bottom pivot block support 184 and fixed to lower column 122 by the use of collar locks 198 to prevent the pivot bearing blocks from sliding in a downward direction along lower column 122. Collar stop 198 is fixed to lower column 122 by the use of a threaded collar lock 200 inserted into appropriate threaded openings (not shown) of collar stop 198. The same arrangement can be used for collar stops 194 and 196 illustrated in FIG. 3. Collar stops 194, 196, 198 therefore serve as a mechanism for maintaining the load of both the retrofit assembly 10 and transport unit 20 on wheels 50, 52 of drive assembly 48.

Once retrofit assembly 10 is installed on transport unit 20 in the manner of replacing the functionality of caster wheels 45, 46 as described herein, the operation of retrofit assembly for the movement of transport unit 20 is initiated by powering motor 110 with rheostat speed controller depicted as 154 (FIG. 2) or 157 (FIG. 7), depending on which embodiment is used, and selecting the forward or reverse direction of the transport unit using any type of forward and reversing switch 152 as the direction controller 158. When transport unit 20 is at a standstill, the combined weight of retrofit assembly 10 and transport unit 20 creates a downward force on wheels 50, 52. As such, a certain amount of torque applied to steering column 68 via tiller 140 will be required to turn axle 34 and wheels 50, 52 in either direction as shown by the rotational arrow 202 in FIG. 7.

As best seen in FIG. 2, in order to facilitate the turning of wheels 50, 52 while transport unit 10 is at a standstill, the bias force of spring 64, 66 against wheels 50, 52 is adjusted to be equal to or greater the load force being applied downward from the scaffolding platform carrying the worker and his tools and materials. As the unit is turned in either direction, one wheel will cause to advance while the other will cause to slip against the slip drive wheel. For example if the rider desires to turn the unit to the right, the left wheel 52 will cause to advance and the right wheel 50 will cause to slip against slip drive wheel 56. The opposite is true when turning in the other direction. Adjustment of the bias force can be undertaken by moving split ring collars 60, 62 along axle 34 towards or away from respective wheels 50, 52. If more bias force is desired, and hence more torque for carrying requisite loads upon the scaffold platform, split ring collars 60, 62 can be moved closer to their respective wheels 50, 52. If less is required, then the split ring collars are moved in the opposite direction and locked in place with respective set screws 61, 63.

With the beveled interface arrangement between wheels 50, 52 and slip drive wheels 54, 56 an efficient and practical mechanism is established for the engagement of the slip drive wheels with their respective freely rotating wheels. This provides the necessary fixation for the movement of wheels 50, 52 and hence the transport unit 20, to a desired location. These features greatly enhance the maneuverability of the transport unit. In addition, the design and portability of motorized retrofit assembly 10 lends itself to being adaptable to a wide variety of scaffolding apparatus, particularly in the construction industry, while at the same time aids in the safe motorized conveyance of transport units and their contents.

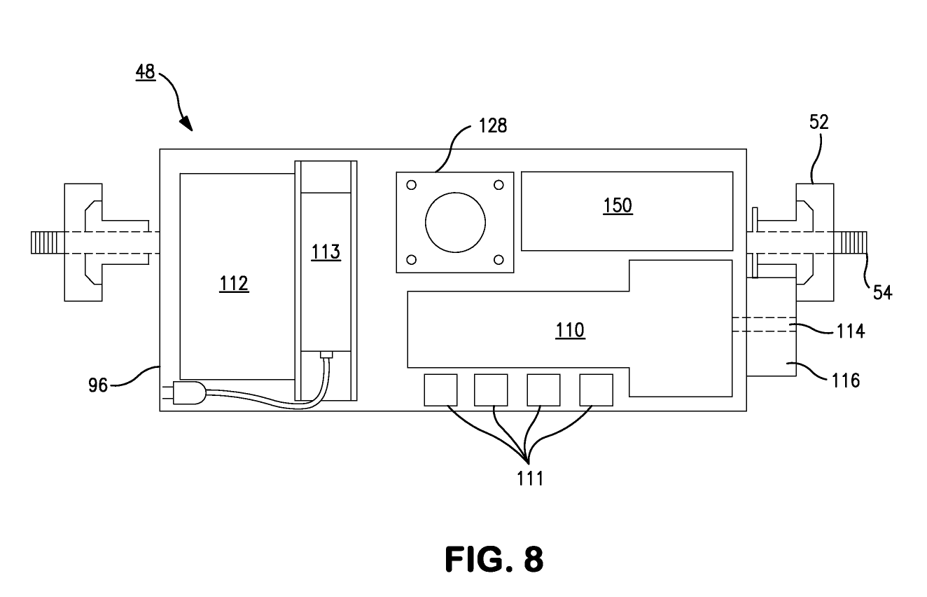

An alternate embodiment of the base is illustrated in FIG. 8. A battery charging unit 113 is mounted to an aluminum angle member 115 which mounts the battery 112 to the base. Four relays 111 function to interface between the motor 110 and the controller within the enclosure 150.

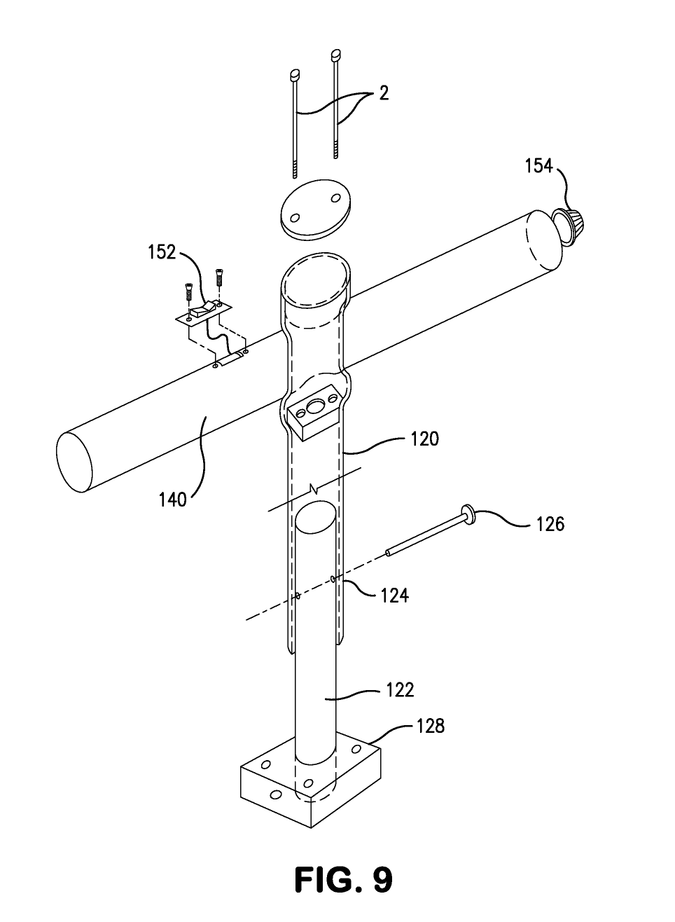

An alternative embodiment of the tiller and telescopic steering column is illustrated in FIG. 9. A rocker switch 159 may be mounted to provide for forward and reverse control of the motor. A rheostat 154 is mounted at the end of the tiller to control the speed of the motor. In another embodiment (not illustrated), the controls are configured and mounted similar to those of a motorcycle throttle.

Since other modifications and changes may be varied to fit the particular operating requirements and environments of the invention, which will be apparent to those skilled in the art, the apparatus herein is not considered to be limited to the embodiments chosen for purposes of disclosure, and covers all changes and modifications which do not constitute departures from the true spirit and scope thereof.

1. A motorized, two-wheeled retrofit assembly for incorporation with a portable, four-wheeled transport unit that includes a relatively open framework, for directionally moving the unit from one location to another, comprising:
a) a drive assembly that includes (i) a pair of rotating wheels spaced apart from each other by a common axle, each wheel being disposed adjacent to and detachably engaged with a slip drive wheel fixed to said axle, said engagement being created by a bias means exerted on said wheels against said respective slip drive wheels; (ii) a motor; (iii) a drive mechanism operatively interconnecting said motor and one of said slip drive wheels for turning said axle; (v) a power source for powering said motor; and (vi) a base communicating with said axle for carrying said motor and said power source; and
b) a steering assembly comprising (i) a vertically adjustable steering column communicating with the base of the drive assembly for turning the drive assembly to a desired position for the directional movement of said wheels; (ii) a steering mechanism disposed about the top portion of said steering column for turning the steering column and drive assembly; and (iii) a control apparatus disposed about said steering mechanism and operatively communicating with said motor for electronically controlling the rotational movement of said wheels.

2. The retrofit assembly of claim 1 wherein the transport unit is a scaffold.

3. The retrofit assembly of claim 1 wherein the engagement of said wheel with its corresponding slip drive wheel is provided by interfacing surfaces on each of said wheels and respective slip drive wheels, and said bias means comprises a spring mechanism mounted about the longitudinal axis of said axle and held in place by a locking mechanism detachably mounted about said axle exteriorly of the spring mechanism.

4. The retrofit assembly of claim 3 wherein the interfacing surfaces of said wheel and slip drive wheel are at an angle of from 0 to 90 degrees relative to the horizontal axis of said axle.

5. The retrofit assembly of claim 3 wherein the bias exerted on said wheel by said spring mechanism is adjustable for allowing the disengagement of the wheel and slip drive wheel from each other when the necessary torque for turning the drive assembly is exceeded.

6. The retrofit assembly of claim 1 wherein the drive mechanism comprises a pulley secured to a drive shaft extending from said motor, and at least one drive belt that interconnects with said pulley and said slip drive wheel.

7. The retrofit assembly of claim 1 wherein the motor is a reversible, variable speed motor.

8. The retrofit assembly of claim 1 wherein the power source is a battery.

9. The retrofit assembly of claim 1 wherein said base is secured to said axle with at least two bearing assemblies, each of said bearing assemblies comprising a block member that includes an opening for receiving a bearing means about the circumference thereof for receiving said axle therethrough.

10. The retrofit assembly of claim 1 wherein the steering column comprises at least two concentric and mateable tubes for varying the height of said steering column.

11. The retrofit assembly of claim 10 wherein each tube includes at least one pair of openings, each located opposite to each other, for receiving therethrough a cross member for maintaining the height of said steering column.

12. The retrofit assembly of claim 1 wherein said steering mechanism comprises at least one handle bar or tiller.

13. The retrofit assembly of claim 1 wherein the control apparatus includes a speed control unit for varying the speed of said motor.

14. The retrofit assembly of claim 1 wherein the control apparatus includes an electrical switch unit for controlling the forward or reverse directional movement of said motor.

15. The retrofit assembly of claim 1 additionally comprising an attachment device for detachably securing said retrofit assembly to one end of the transport unit.

16. The retrofit assembly of claim 15 wherein the attachment device comprises:
(i) at least one plate member comprising a plurality of openings for receiving the ends of at least one C-bolt therethrough; and
(ii) fastening means for detachably engaging the ends of said C-clamp;
wherein said openings, C-bolt and fastening means cooperate to engage said plate member with said transport unit.

17. A self-propelling transport unit comprising a motorized retrofit assembly incorporated with a portable, open-framed scaffold,
A) said scaffold including a front and rear framework, each framework comprising a plurality of cross members communicating with upright corner members, each corner member comprising a support wheel about the base thereof, and said front and rear frameworks being connected by transverse members for supporting a platform between said front and rear frameworks; and
B) said retrofit assembly comprising:
(a) a drive assembly that includes (i) a pair of freely rotating wheels spaced apart from each other by a common axle, each wheel being disposed adjacent to and detachably engaged with a slip drive wheel fixed to said axle, said engagement being created by a bias means exerted on said wheels against said respective slip drive wheels; (ii) a motor; (iii) a drive mechanism operatively interconnecting said motor and one of said slip drive wheels for turning said axle; (iv) a power source for powering said motor; and (v) a base communicating with said axle for carrying said motor and said power source; and
(b) a steering assembly comprising (i) a vertically adjustable steering column communicating with the base of the retrofit assembly for turning said drive assembly to a desired position for the directional movement of said wheels; (ii) a steering mechanism disposed about the top portion of said steering column for turning the steering column and drive assembly; and (iii) a control device disposed about said steering mechanism, operatively communicating with said motor for controlling the rotational movement of said wheels; and
(c) an attachment device for detachably securing said retrofit assembly to the front framework of the scaffold in a manner that immobilizes the support wheels of the front framework of said scaffold.

18. The self-propelling transport unit of claim 17 wherein the engagement of said wheel with its corresponding slip drive wheel is provided by interfacing surfaces on each of said wheels and respective slip drive wheels, and said bias means comprises a spring mechanism mounted about the longitudinal axis of said axle and held in place by a locking mechanism detachably mounted about said axle.

19. The self-propelling transport unit of claim 18 wherein the bias exerted on said wheel by said spring mechanism is adjustable for allowing the disengagement of the wheel and slip drive wheel from each other when the necessary torque for turning the drive assembly is exceeded.

20. A self-propelling transport unit comprising a motorized retrofit assembly incorporated with a portable, open-framed scaffold,
A) said scaffold including a front and rear framework, each framework comprising a plurality of cross members communicating with upright corner members, each corner member comprising a support wheel about the base thereof, and said front and rear frameworks being connected by transverse members for supporting a platform between said front and rear frameworks; and
B) said retrofit assembly comprising:
(a) a drive assembly that includes (i) a pair of freely rotating wheels spaced apart from each other by a common axle; (ii) a drive wheel operatively communicating with said axle for turning the axle; (iii) a motor; (iv) a drive mechanism operatively interconnecting said motor and said drive wheel for turning said axle; (v) a power source for powering said motor; and (vi) a base communicating with said axle for carrying said motor and said power source;
(b) a steering assembly comprising (i) a vertically adjustable steering column communicating with the base of the drive assembly for turning said drive assembly to a desired position for the directional movement of said wheels; (ii) a steering mechanism disposed about the top portion of said steering column for turning the steering column and drive assembly; and (iii) a control device disposed about said steering mechanism, operatively communicating with said motor for controlling the rotational movement of said wheels; and
(c) an attachment device for detachably securing said retrofit assembly to the front framework of the scaffold in a manner that immobilizes the support wheels of the front framework of said scaffold.
